(19) United States
(12) Patent Application Publication
(10) Pub. No.: US 2017/0019312 A1
(43) Pub. Date: Jan. 19, 2017

(54) NETWORK ANALYSIS AND MANAGEMENT SYSTEM

(71) Applicant: Brocade Communications Systems, Inc., San Jose, CA (US)

(72) Inventors: David Meyer, Eugene, OR (US); Derick Winkworth, Port Washington, WI (US)

(21) Appl. No.: 15/211,923

(22) Filed: Jul. 15, 2016

Related U.S. Application Data
(60) Provisional application No. 62/193,998, filed on Jul. 17, 2015.

(51) Int. Cl. H04L 12/24; H04L 12/26; G06N 5/04

(52) U.S. Cl. CPC H04L 41/16; G06N 5/048; H04L 43/10

(57) ABSTRACT

Techniques are described for improved network analysis and management. In certain embodiments, multiple analysis techniques may be applied to network data collected or obtained otherwise for a network. Correlations between the results of the multiple analysis techniques may then be determined. One or more inferences identifying one or more conditions or events associated with the network may then be drawn based upon the correlations. An inference can identify a past or present condition or predict the occurrence of a future network-related condition or event. One or more actions to be executed may be determined based upon the one or more inferences. The actions may include corrective actions to correct an existing adverse condition or preemptive actions that are meant to reduce or mitigate an adverse impact of a future condition or event on the network.

### CROSS-REFERENCES TO RELATED APPLICATIONS

This patent application claims priority to U.S. Provisional Patent Application Ser. No. 62/193,998, filed Jul. 17, 2015, entitled “MACHINE LEARNING BASED NETWORK MONITORING AND MANAGEMENT,” the content of which is incorporated herein by reference in its entirety for all purposes.

### BACKGROUND

Data networks have seen an exponential growth in recent times due to advances in processing capabilities and the emergence of new technologies such as cloud computing, multimedia enabled applications, large data center-centric applications, and the like. The increased complexity of such data networks has made the task of managing today's networks very difficult.

Traditionally, network management is performed by human network administrators based upon network data collected for a network. A human network administrator manually analyzes the collected or monitored network data and makes network configuration decisions. However, given the size and complexity of today's networks, the amount of network data that is collected is huge, making it very difficult, if not impossible, for a human network administrator to properly analyze the data manually. The human component involved in the network management also increases the chance of an error and/or increases the response time. As a result, traditional methods of network management are quickly becoming impractical and/or unusable for managing today's networks.

### BRIEF SUMMARY

The present disclosure generally relates to networking, and more specifically to improved techniques for network control and management. In certain embodiments, improved techniques, including machine-learning based techniques, are disclosed for analyzing monitored network data and, based upon the analysis, determining and taking anticipatory and/or corrective network management actions to eliminate or minimize the occurrences of network conditions or events that could adversely impact the functioning of the network.

Various techniques (e.g., systems, devices, methods, apparatus, and non-transitory computer-readable medium or devices storing code or computer instructions executable by one or more processing entities such as processors and/or cores) are described for performing network analysis and management. More specifically, in certain embodiments, multiple analysis techniques may be applied to network data collected or obtained otherwise for a network. Correlations between the results of the multiple analysis techniques may then be determined. One or more inferences related to the network may then be drawn based upon the correlations. One or more actions may be determined based upon the inferences.

In certain embodiments, the network data to which the multiple analysis techniques are applied may be stored in the form of network records, each network record comprising multiple attributes. In some embodiments, the multiple analysis techniques may be applied to the multiple attributes of the network records. In some embodiments, the multiple analysis techniques may be applied to different sets of attributes from the multiple attributes for the network records. For example, a first analysis technique may be applied to a first set of attributes of the network records from the multiple attributes and the second analysis technique may be applied to a second set of attributes of the network records from the multiple attributes, where the second set of attributes may be different from the first set of attributes.

As indicated above, in certain embodiments, an inference related to the network may be generated based upon the correlations between the results of the multiple analysis techniques. The inference may be related to a condition or event associated with a network. In some instances, the inference may be about an event of condition that is about to occur or likely to occur in the network in the future. The inference may be related to a condition or event that already exists in the network. An action may then be determined based upon the inference. An action may be such that it affects one or more network devices in the network. The action may then be scheduled or initiated. In some instances, the action may be a preemptive or anticipatory action to prevent an adverse condition or event from occurring in the network. In other instances, the action may be a remedial or corrective action to remedy or correct a current adverse condition or event in the network. In certain embodiments, the action may be scheduled for execution at a later time such that the action may be performed before the anticipated occurrence of a predicted network condition or event. In some instances, the action may be a notification to a network administrator or operator.

In some embodiments, a method that may be performed by a computing system is disclosed. In certain embodiments, the method may include applying a first analysis technique to a set of network records to generate a first analysis result and applying a second analysis technique to the set of network records to generate a second analysis result. The set of network records may include network data collected for a network that includes multiple network devices, such as routers, switches, and the like. Each network record of the set of network records may include multiple attributes. The method may further include determining a correlation between the first analysis result and the second analysis result; determining an inference related to the network based upon the correlation; and then determining an action to take for the network based upon the inference.

In certain embodiments of the method that may be performed by the computing system, applying the first analysis technique may include applying the first analysis technique to a first set of attributes from the multiple attributes of the set of network records; and applying the second analysis technique may include applying the second analysis technique to a second set of attributes from the multiple attributes of the set of network records, where the second set of attributes may be different from the first set of attributes. In certain specific embodiments, the first set of attributes may include a categorical attribute and the second set of attributes may include a numerical attribute. In some embodiments, the first analysis technique may include at least one of a frequent pattern (FP) analysis technique, a latent Dirichlet allocation (LDA) analysis technique, an Apriori analysis technique, or an FP-growth analysis technique for analyzing a categorical attribute of the set of network records, and the second analysis technique may include at least one of a K-means analysis technique, a principal component analysis (PCA) technique, a singular value decomposition (SVD) technique, an incremental clustering technique, or a probability-based clustering technique for analyzing a numerical attribute of the set of network records.

In some embodiments of the method that may be performed by the computing system, the first analysis technique may be different from the second analysis technique, and the first analysis technique and the second analysis technique may be applied to a same set of attributes from the multiple attributes. In some embodiments, the first analysis technique and the second analysis technique may be a same analysis technique, and the first analysis technique and the second analysis technique may each be applied to a different set of attributes of the multiple attributes. In some embodiments, the method may further include selecting the first analysis technique and the second analysis technique based at least partially upon the set of network records.

In some embodiments of the method that may be performed by the computing system, determining the correlation between the first analysis result and the second analysis result may include selecting a correlation rule for the correlation from a set of correlation rules. In some embodiments, the correlation may include an intersection of the first analysis result and the second analysis result.

In some embodiments of the method that may be performed by the computing system, the inference related to the network may identify a network condition or event, which, in some instances, may include a predicted future network condition or event.

In some embodiments of the method that may be performed by the computing system, the action to take may be determined by identifying a network condition or event based upon the inference related to the network, and searching an action table that stores multiple network conditions or events and their corresponding actions to identify a network condition or event that matches the network condition or event identified based upon the inference. When a matching network condition or event is identified in the action table, the action corresponding to the matching network condition or event in the action table may be identified as the action to take. In some embodiments, the action to take may affect at least one network device from the multiple network devices. In certain embodiments, the action may include rerouting network traffic through a high-bandwidth path or rerouting network traffic through a low-latency path. In some embodiments, the identified action to take may be scheduled for execution at a future time.

### BRIEF DESCRIPTION OF THE DRAWINGS

Various embodiments in accordance with the present disclosure will be described with reference to the drawings, in which:

FIG. 1 is a simplified high-level block diagram illustrating details of a network analysis and management system, according to certain embodiments;

FIG. 2 is a simplified high-level flow chart illustrating a method performed by a network analysis and management system according to certain embodiments;

FIG. 3 is a simplified block diagram of an analysis engine of a network analysis and management system according to certain embodiments;

FIG. 4 is a simplified flow chart depicting a method of performing network analysis, according to certain embodiments;

FIG. 5 is a high-level flow chart illustrating processing performed for action recommendation according to certain embodiments;

FIG. 6 illustrates an example action table;

FIG. 7 illustrates a specific use case example that uses FP analysis and K-Mean analysis techniques; and

FIG. 8 depicts a simplified block diagram of a computing system that may be used to implement a network analysis and management system according to certain embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The present disclosure generally relates to networking, and more specifically to improved techniques for network analysis and management. In certain embodiments, improved techniques, including machine-learning based techniques, are disclosed for analyzing monitored network data and, based upon the analysis, determining and taking anticipatory and/or corrective network management actions to eliminate or minimize the occurrences of conditions or events that could adversely impact the functioning of the network.

Various techniques (e.g., systems, devices, methods, apparatus and non-transitory computer-readable medium or devices storing code or computer instructions executable by one or more processing entities such as processors and/or cores) are described for performing network analysis and management. More specifically, in certain embodiments, multiple analysis techniques may be applied to network data collected or obtained otherwise for a network. Correlations may then be determined between the results of the multiple analysis techniques. One or more inferences related to the network may then be drawn based upon the correlations. One or more actions may be determined based upon the inferences.

In certain embodiments, the network data to which the multiple analysis techniques are applied may be stored in the form of network records, each network record comprising multiple attributes. In some embodiments, the multiple analysis techniques may be applied to the multiple attributes of the network records. In some embodiments, the multiple analysis techniques may be applied to different sets of attributes from the multiple attributes for the network records. For example, a first analysis technique may be applied to a first set of attributes of the network records from the multiple attributes and the second analysis technique may be applied to a second set of attributes of the network records from the multiple attributes, where the second set of attributes may be different from the first set of attributes.

As indicated above, in certain embodiments, an inference related to the network may be generated based upon the correlations between the results of the multiple analysis techniques. The inference may be regarding a past, present, or future condition or event related to the network. An action to be performed may then be determined based upon the inference. In some embodiments, the action may be a preemptive or anticipatory action to take prior to, and in anticipation of, the occurrence of a predicted future network-related condition or event. The preemptive or anticipatory action, for example, maybe scheduled for execution such that the action is performed before the anticipated occurrence of the predicted network condition or event. In some embodiments, the action may be a corrective or remedial action regarding a past or present network condition or event. In some instances, the action may be a notification to a network administrator or operator.

In certain embodiments, an architecture of a system for performing network analysis and management is disclosed. In one embodiment, a network analysis and analysis system is configured to collect network data for a network comprising various network devices, such as routers, switches, and the like. The collected network data may include multiple network records, where each network record of the multiple network records may include multiple attributes. The network analysis and management system may be configured to process and analyze the collected network data. In certain embodiments, the processing and analyzing may include, without restriction, pre-processing (e.g., normalizing) the collected network data, applying a first analysis technique to the collected network data to generate a first analysis results, applying a second analysis technique to the collected network data to generate a second analysis results, and determining a correlation between the first analysis results and the second analysis results. The correlation may then be used to draw inferences related to the network. These inferences may include, for example, detecting or predicting the occurrence of an event or condition associated with the network. The inferences may also be used to identify one or more actions to be taken in response to or in anticipation of the detected event(s) or condition(s).

Various different conditions and events may be detected or predicted as part of an inference. Examples of conditions may include without limitation congestion-related conditions (e.g., congestion in a particular portion of the network), network connectivity-related conditions (e.g., loss connectivity), Quality of Service (QoS) related conditions, network security-related conditions, network orchestration and optimization-related conditions, and the like. Examples of events may include without limitation events that impact network functionality such as events that affect network bandwidth or congestion (e.g., a burst of packets sent by a network application), events affecting network connectivity (e.g., addition or removal of network devices or links from the network), events that affect network security (e.g., a Denial of Service (DoS) attack), events that impact QoS, events that impact the availability of the network (e.g., failure of a network device in the network, failover events), events that impact network orchestration and optimization, and the like.

In certain embodiments, the network analysis and management system may use a set of action rules to determine the actions to be taken based upon the inferences. These action rules may be configured by a system administrator or may be learned by the network analysis and management system, for example, using machine-learning techniques. In certain embodiments, an action rule may identify a condition or event and corresponding one or more actions to be executed when the past, present, or future predicted occurrence of the condition or event in the network is inferred. The actions may include actions that affect one or more network devices in the network, for example, actions that make configuration and/or data path changes to one or more network devices in the network, make changes to forwarding tables for one or more network devices in the network, make changes to QoS parameters for different network traffic streams handled by one or more network devices in the network, and the like.

In instances where an inference identifies an existing condition or event in the network, the one or more actions that are determined to be taken may be such that the execution of the one or more actions corrects or mitigates the impact of the condition on the functioning of the network. In this manner, an adverse network condition or event may be corrected promptly by a corrective action that is determined and performed.

In instances where the inference predicts the possible future occurrence of a condition or event in the network, the one or more actions that are determined to be taken may be such that the execution of the one or more actions eliminates or reduces the chance of that condition or event occurring, or preemptively reduces or mitigates the adverse impact of the condition or event on the network when the condition or event does occur. Such an action may be scheduled for execution prior to the occurrence of the particular event or condition. In this manner, an anticipatory remedial action may be taken upon inferring the potential for an adverse network condition or event occurring in the future.

In the following description, some embodiments in accordance with the present disclosure will be described in detail with reference to the drawings.

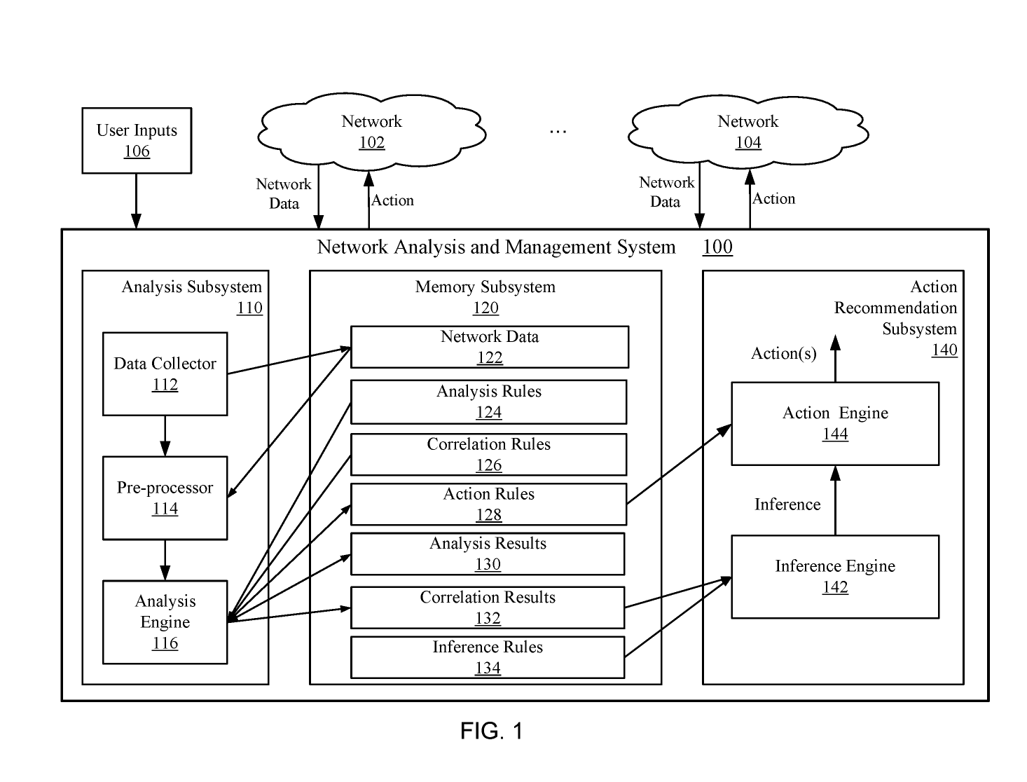

FIG. 1 is a simplified high-level block diagram of a network analysis and management system (NAMS) 100 according to certain embodiments. As shown in FIG. 1, NAMS 100 may include various subsystems including an analysis subsystem 110, a memory subsystem 120, and an action recommendation subsystem 140. NAMS 100 may be in communication with one or more networks (e.g., network 102 and network 104 depicted in FIG. 1) for collecting network data and managing the one or more networks. NAMS 100 may also provide an interface for receiving user inputs 106. NAMS 100 depicted in FIG. 1 is merely an example and is not intended to be limiting. One of ordinary skill in the art would recognize many possible variations, alternatives, and modifications. For example, in some implementations, NAMS 100 may have more or fewer components than those depicted in FIG. 1, may combine two or more components, or may have a different configuration or arrangement of components.

Memory subsystem 120 represents the non-transitory memory resources of NAMS 100 and may include one or more memories including volatile and/or non-volatile memories. For example, memory subsystem 120 may include a persistent storage, system memory (e.g., Random Access Memory (RAM)), and the like. Memory subsystem 120 may store the data and other constructs used by NAMS 100. For example, as shown in FIG. 1, memory subsystem 120 may store network data 122, various rules used by NAMS 100 for performing its network analysis and management (e.g., analysis rules 124, correlation rules 126, action rules 128, and inference rules 134), various results generated by NAMS 100 (e.g., analysis results 130 and correlation results 132), and other data or information. In certain embodiments, memory subsystem 120 may also store code, program, or instructions that, when executed by one or more processing entities of NAMS 100, provide the functionality of NAMS 100.

At a high level, NAMS 100 may be configured to receive network data for a particular network domain or network, process and analyze the collected network data to generate analysis results, and perform one or more correlations on the analysis results. NAMS 100 may then use the correlation result(s) to make one or more inferences. An inference may identify a condition or event that existed or occurred in the particular network in the past, identify a condition or event that exists or occurs in the network presently, or predict the likely occurrence of a condition or event sometime in the future. Based upon the inferences, NAMS 100 may then determine one or more actions to be taken. The one or more actions may then be initiated or scheduled for execution. The one or more actions may include actions that affect one or more network devices in the particular network being managed.

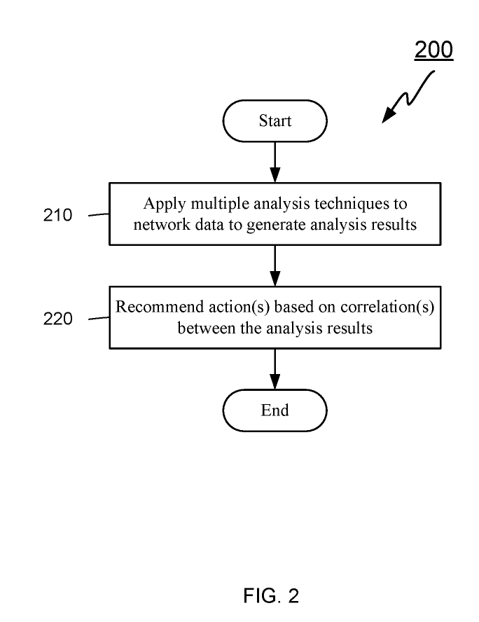

FIG. 2 depicts a simplified high-level flow chart 200 illustrating a method performed by a network analysis and management system, such as NAMS 100 depicted in FIG. 1 according to certain embodiments. The method presented in FIG. 2 and described below is intended to be illustrative and non-limiting. The particular series of processing steps depicted in FIG. 2 is not intended to be limiting. As depicted in FIG. 2, the processing in flow chart 200 includes two phases: an analysis phase at 210 and an inference and action recommendation phase at 220.

At 210, NAMS 100 may be configured to apply multiple analysis techniques to network data for a particular network that is to be managed. Multiple analysis results may be generated in 210 as a result of applying the multiple analysis techniques. As part of the processing in 210, NAMS 100 may receive or collect network data for the particular network. NAMS 100 may then apply multiple analysis techniques to the network data to generate multiple analysis results. As part of 210, NAMS 100 may also find correlations between two or more of the analysis results and generate correlation results.

At 220, NAMS 100 may be configured to recommend one or more actions based upon the correlation between the analysis results performed in 210. As part of the processing in 220, NAMS 100 may make an inference related to the network based upon the correlation results generated in 210. For example, based upon the correlation results, NAMS 100 may draw an inference that identifies a past or present network condition or event, or predicts the likely occurrence of a condition or event associated with the network in the future. In certain embodiments, a set of inference rules 134 may be used by NAMS 100 to determine the inferences. Further, as part of 220, upon detecting or predicting a network condition or event, NAMS 100 may then determine one or more actions to be executed in response to the determined inference. In certain embodiments, an action to be performed may be determined based upon action rules 128 accessible to NAMS 100. In some embodiments, the action rules may be configured by a user of NAMS 100, such as a system administrator, and may be stored in a memory or database of NAMS 100. For example, the rules may be provided as user inputs 106 in FIG. 1 and stored in memory 120 of NAMS 100. In some other embodiments, NAMS 100 may learn the action rules based upon the network data, such as using various auto-learning techniques, including machine learning techniques. NAMS 100 may then schedule the one or more actions for execution or cause the one or more actions to be executed promptly after the detection of the past or present event, or preemptively prior to the predicted occurrence of the network condition or event.

In some implementations, the processing performed in 210 and 220 may be executed in series or in parallel. Further, the processing performed in flow chart 200 may be performed iteratively. For example, as more network data is collected and received by NAMS 100, further analysis including the processing in 210 and 220 may be performed, and the action rules may be updated as a result of the further analysis. In addition, a feedback loop may be provided that enables the accuracy of the inference (e.g., determination of a past, present, or future condition or event) and the effectiveness of the action recommendation to be verified, and the verification results may be fed back to NAMS 100 to improve or optimize processing of NAMS 100 including updating the inference and action rules. Accordingly, the inference and action rules may be updated and improved in real time. As a result, the inferring capability of NAMS 100 and the action recommendation capability of NAMS 100 may be automatically and dynamically changed and improved over time as more data becomes available and is subject to the analysis

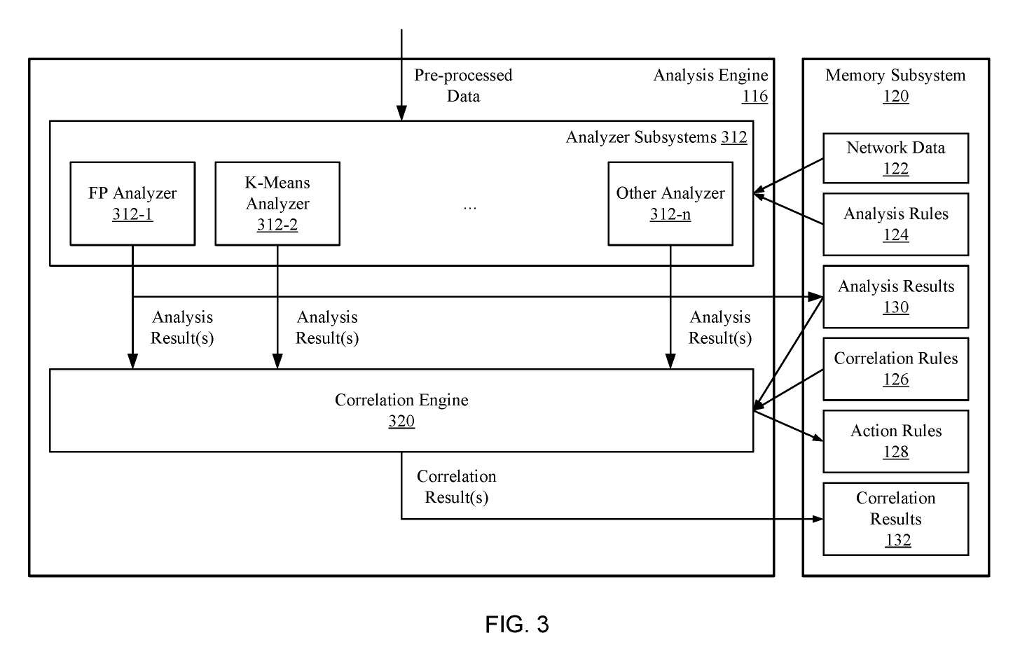

In the example embodiment depicted in FIG. 1, the processing in 210 may be performed by, for example, analysis subsystem 110 depicted in FIG. 1, and the processing in 220 may be performed by, for example, analysis subsystem 110 and action recommendation subsystem 140. Further details related to analysis subsystem 110 and action recommendation subsystem 140 are provided below with respect to FIGS. 3-5.

Referring back to FIG. 1, in one example, analysis subsystem 110 may itself include multiple subsystems including a data collector 112, a pre-processor 114, and an analysis engine 116. Data collector 112 may be configured to collect or receive network data that is analyzed by NAMS 100 and used to manage one or more networks. In certain embodiments, the network data for a network may comprise multiple network records, for example, for network 102 or network 104, and may be received via one or more network controllers in the networks. Data collector 112 may use various different methods to receive or collect the network data. For example, the network data may be collected from a network continuously or periodically using, for example, OpenFlow or other protocols. In certain embodiments, data collector 112 may collect data from network 102 or 104 on a periodic basis, such as every second, every 30 seconds, every minute, every few minutes (e.g., 5 minutes), etc. Various push and/or pull techniques may be used to collect the network data. In some other embodiments, data collector 112 may receive network data for a network in real time as the data becomes available.

The network data received or collected by data collector 112 for a network, such as network 102 or 104, may include various types of data such as data about various states of the network, data related to events occurring in the network, data about the network devices in the network, data related to data paths within the network, data related to the identification of the sources and destinations of the packets data, data related to the flow of traffic through the network, and the like. The network data may include different attributes, each attribute identifying a piece of information related to the network For example, in certain embodiments, the network data may include data related to addresses (e.g., Internet Protocol (IP) addresses) of the sources and destinations of network data flows, applications generating the data, the endpoints an application talks to, the ports and protocols used, flow characteristics (e.g., flow identification information (ID)), time of delay, data volume, and duration of the application or the network activity, and the like.

In certain embodiments, the network data received by data collector 112 may be stored and persisted as network data 122 in memory subsystem 120 so that the data is available to other subsystems of NAMS 100 for processing. Data collector 112 may also forward the received network data to a pre-processor 114 for further processing.

In certain embodiments, the network data collected or received by NAMS 100 may be in the form of multiple network records, each record comprising multiple attributes. In one embodiment, the network records may be stored in a database in memory 120. For example, the network data may be stored in database table, with the rows of the table representing the multiple network records and the columns of the database table representing the various attributes of each network record.

The attributes of the network records may be of various types. For example, the attributes of a network record may include categorical attributes and numerical attributes. A categorical attribute may be an attribute that cannot be compared using an Euclidian similarity or distance metric, but can be sorted into groups or categories, such as a qualitative property, a category, a class, a type, an identification, etc. Examples of categorical attributes of a network record include network protocols, types of applications, IP addresses, network ports, flow IDs, interface types, and the like. A numerical attribute is an attribute that can be compared using an Euclidian similarity or distance metric, such as one that can be measured and identified by discrete or continuous numerical values. Examples of numerical attributes of a network record include, for example, a time instant, a time period, or a number of packets, etc.

In certain embodiments, pre-processor 114 may be configured to pre-process the network data, such as normalizing the network data received by data collector 112 and preparing it in a format that can be consumed by various analysis techniques. In certain embodiments, the normalization may include, for example, organizing the network data into blocks of data for individual time periods, such as one-minute or five-minute time blocks. Information identifying the time periods may be provided by a user of NAMS 100 using user inputs 106. Different data normalization operations may be performed for different fields or attributes of the network data. For example, different processing may be performed based upon the type of an attribute, for example, whether it is a categorical or a numerical attribute. For example, for numerical attributes may be normalized differently from categorical attributes. The processing performed by pre-processor 114 may be performed nearly in real time as soon as the network data is collected by or becomes available to data collector 112 or may be performed at a later time. In certain embodiments, the data generated or output by pre-processor 114 may also be stored as part of network data 122 in memory subsystem 120 from where it is accessible to other subsystems of NAMS 100. The data output by pre-processor 114 may also be forwarded to analysis engine 116 for further analysis.

Analysis engine 116 may be configured to analyze network data collected by data collector 112 or data pre-processed by pre-processor 114. As part of this analysis, analysis engine 116 may be configured to apply multiple analysis techniques to the network data to generate multiple analysis results and determine correlations between two or more of the analysis results. The multiple analysis techniques may include one or more supervised or unsupervised machine learning techniques such as a Frequent Pattern (FP) analysis technique, a K-means analysis technique, and others. The FP analysis technique is a well-known analysis technique that is used to find relations and patterns that occur in an input data set. For example, the FP analysis technique may be used to find patterns in network data sets based upon network protocols, user applications, and the like. The K-means analysis technique is a well-known unsupervised learning technique that clusters data points in an input data set into a number of cohesive disjoint clusters, where the “K” parameter indicates the number of clusters. The multiple analysis results that are generated by applying the multiple analysis techniques may be stored in memory 120 as analysis results 130. The results from performing correlations between two or more of the analysis results may be stored in memory 120 as correlation results 132.

Multiple analysis techniques may be available to analysis engine 116 for applying to the network data. In certain embodiments, information identifying the various available analysis techniques may be stored as analysis rules 124. For a particular analysis technique, information used by the analysis technique may also be stored as part of analysis rules 124. For example, for a particular analysis technique, analysis rules 124 may include, for example, information identifying the attributes to be used for that particular analysis technique, and the like. In some instances, the same attributes of the network data may be used by a first analysis technique and a second analysis technique. In some other instances, multiple analysis techniques may be applied to different sets of attributes from the multiple attributes of the network data. For example, a first analysis technique may be applied to a first set of attributes of the network data from the multiple attributes and a second analysis technique may be applied to a second set of attributes of the network data from the multiple attributes, where the second set of attributes may be different from the first set of attributes. In some instances, there may be no overlap between attributes used for a first analysis technique and attributes used for a second analysis technique.

In some embodiments, the two or more analysis techniques that are to be applied to the network data may be selected automatically by NAM 100 from multiple available analysis techniques based upon the characteristics of the network data, such as, for example, based upon the attributes of the network data. In some other embodiments, a user of NAMS 100 may configure NAMS 100 to apply certain specified analysis techniques to the network data depending on the characteristics of the network data.

As indicated above, analysis engine 116 is configured to find correlations between multiple analysis results generated from applying multiple analysis techniques. The results of the correlation processing may be stored in memory 120 as correlation results 132. In certain embodiments, analysis engine 116 may use a set of correlation rules 126 accessible to NAMS 100 to perform the correlation operation. Correlation rules 126 may specify the specific analysis techniques whose analysis results are to be used for the correlation operation and the specific correlation operation to be performed for a specific set of two or more analysis techniques.

FIG. 3 is a simplified block diagram of an example analysis engine 116 of NAMS 100 according to certain embodiments. As shown in FIG. 3, analysis engine 116 may include various subsystems including multiple analyzer subsystems 312 and a correlation engine 320. Analyzer subsystems 312 may include multiple subsystems with each analyzer subsystem configured to apply a specific corresponding analysis technique to the network data. For example, in the example depicted in FIG. 3, analyzer subsystems 312 include a Frequent Pattern (FP) analyzer 312-1, a K-means analyzer 312-2, and other analyzer subsystems. FP analyzer 312-1 may be configured to apply the FP analysis technique to the network data. K-means analyzer 312-2 may be used to apply the K-means analysis technique. Other analyzers may be provided for applying various other analysis techniques, such as other association-based techniques, other clustering techniques, and the like. Two or more analyzer subsystems 312 may be selected and used to analyze the pre-processed data from pre-processor 114 or stored network data 122 using analysis rules 124 and/or user inputs 106 as described above. The analysis results from the selected two or more analyzer subsystems 312 may be stored in memory subsystem 120 as analysis results 130 or may be passed on to correlation engine 320 for further processing.

Correlation engine 320 may be configured to perform correlation analysis on analysis results 130 generated by two or more analyzer subsystems 312. In certain embodiments, correlation engine 320 may use correlation rules 126 to perform the correlation processing. For example, in one instance, analysis results generated by FP analyzer 312-1 may be correlated with analysis results generated by K-Means analyzer 312-2. For example, if the results of the FP analysis identified network records exhibiting a certain frequent pattern related to characteristics of data from a specific application, and if the results of the K-means analysis identified clusters of congestion, the two results may be correlated by taking an intersection of the two results. In other examples, the correlation processing between the analysis results of two or more analysis techniques may include other operations other than determining the intersection of the analysis results. The correlation results from correlation engine 320 may be stored in memory subsystem 120 as correlation results 132 and/or may be passed on to action recommendation subsystem 140 for further processing.

In certain embodiments, analysis engine 116 may also be used to generate action rules 128. For example, in some embodiments, appropriate actions to take for various detected or predicted network conditions or events, such as network congestion, long latency, or high traffic volume on certain path of the network, may be determined based upon the analysis of the network records and the correlation between the analysis results. For example, the analysis and correlation performed by analysis engine 116 may infer that network path A may experience a long latency during a time period, while network path B may have a low latency during the same time period. Thus, an entry in the action rule may indicate that, for the condition that network path A may experience a long latency during a time period, the corresponding action to take may be to route network traffic through network path B.

Referring back to FIG. 1, action recommendation subsystem 140 may be configured to determine an inference based upon the correlation results 132 and determine one or more actions to be executed based upon the inference. In certain embodiments, action recommendation subsystem 140 may use inference rules 134 to determine one or more inferences based upon correlation results 132 and then use action rules 128 to determine one or more actions to take for the determined one or more inferences. The actions determined by action recommendation subsystem 140 may then be communicated to the particular network for which the actions are to be taken. The actions may include actions that affect one or more network devices in the particular network. In certain embodiments, an action determined by action recommendation subsystem 140 may be communicated from NAMS 100 to a network controller within the network where the action is to be executed. The network controller may then cause the action to be executed in that network. For example, action recommendation subsystem 140 may be in communication with network 102 or 104 for receiving network data through, for example, a network controller, which may act as a central controller for a network domain comprising multiple network devices, such as network 102 or 104. Action recommendation subsystem 140 may also communicate with network 102 or 104 using the network controller to provide the recommended actions for configuring one or more network devices of the network.

In the example depicted in FIG. 1, action recommendation subsystem 140 comprises an inference engine 142 and an action engine 144. Inference engine 142 may be configured to determine one or more inferences based upon correlation results 132. An inference may identify a past, present, or future condition or event related to the network. An inference may identify a condition or event that existed or occurred in the particular network in the past, identify a condition or event that exists or occurs in the network presently, or predict the likely occurrence of a condition or event in the network sometime in the future.

In certain embodiments, inference engine 142 may use inference rules 134 to make an inference. Inference rules may include, for example, a mapping of correlation results to inferences. An inference in the list of inferences may identify, for example, various detected or predicted conditions or events. Examples of conditions may include without limitation congestion-related conditions (e.g., congestion in a particular portion of the network), network connectivity-related conditions (e.g., loss connectivity or network fault), QoS related conditions, network security-related conditions, and the like. Examples of events may include without limitation events that impact network functionality such as events that affect network bandwidth or congestion (e.g., a burst of packets sent by a network application), events affecting network connectivity (e.g., addition or removal of network devices or links from the network), events that affect network security (e.g., a DoS attack), events that impact QoS, events that impact the availability of the network (e.g., failure of a network device in the network, failover events), abnormal events, and the like.

An inference determined by inference engine 142 for a particular network may be forwarded by inference engine 142 to action engine 144. Action engine 144 is then configured to determine one or more actions to take for the inference. For example, if the inference made by inference engine 142 indicates that a specific path in the particular network may experience a long and unacceptable latency at some future time, the action may include identifying and configuring an alternative path for carrying the network traffic instead of the specific path, where the alternate path has a low acceptable latency before the future time occurs.

Action recommendation subsystem 140 may cause the determined action to be executed or may cause the determined action to be scheduled for execution. In instances where an inference identifies an existing condition or event in the network, the one or more actions that are determined to be taken may be such that the execution of the one or more actions corrects or mitigates the impact of the condition on the functioning of the network. In this manner, an adverse network condition or event may be corrected promptly by a corrective action that is determined and performed. In instances where the inference predicts the possible future occurrence of a condition or event in the network, the one or more actions that are determined to be taken may be such that the execution of the one or more actions eliminates or reduces the chance of that condition or event occurring, or preemptively reduces or mitigates the adverse impact of the condition or event on the network when the condition or event does occur. Such an action may be scheduled for execution prior to the occurrence of the particular event or condition. In this manner, an anticipatory remedial action may be taken upon inferring the potential for an adverse network condition or event occurring in the future. before the

A user of NAMS 100 may configure the functioning of NAMS by providing user inputs 106. For example, a user may configure various rules (e.g., analysis rules 124, correlation rules 126, inference rules 134) using user inputs 106. For example, a user may provide input identifying one or more networks for which network data is to be collected and analyzed. For a particular network, the user may also specify the parameters or attributes of interest for that network. NAMS 100 may also allow the user to customize or change action rules and/or create new user-specific action rules through user inputs 106. For example, action recommendation subsystem 140 may make inferences and determine actions based upon user inputs, such as the inference rule(s) to be used.

In various embodiments, the network analysis and management system disclosed herein may be used for performance management, fault management, configuration management, security management, or accounting management for one or more networks. In the example depicted in FIG. 1 and described above, a single NAMS 100 may be provided for monitoring and managing multiple networks. In certain other embodiments, multiple analysis and management systems may be provided that cooperatively provide network monitoring and management services for multiple networks. The monitoring and management may be related to identifying bottleneck devices and links, monitoring link availability and performance, analyzing traffic usage patterns to learn applications' and users' network behavior, identifying and characterizing network faults, identifying causes of network problems, performing network diagnosis and finding root causes, repairing and restoring the network functionality, detecting network security threats, detect anomalous behavior in a network, and the like.

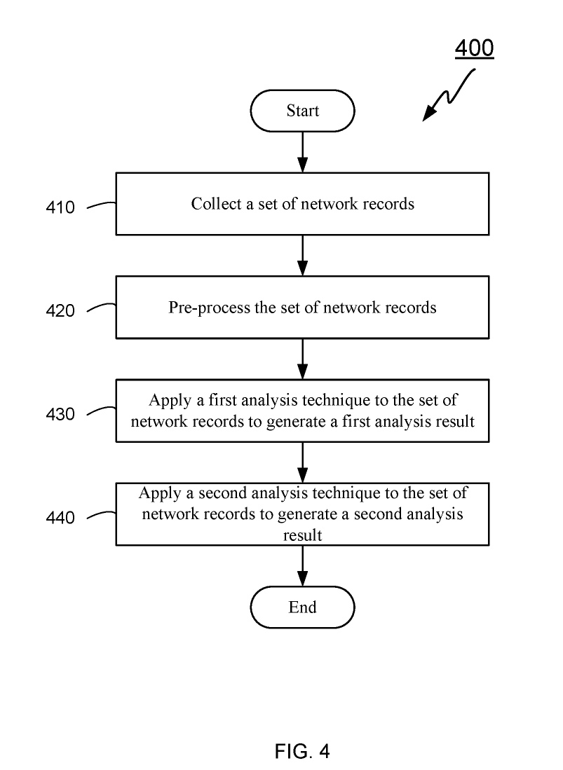

FIG. 4 is a simplified flow chart 400 depicting a method of performing network analysis according to certain embodiments. In certain embodiments, the processing depicted in FIG. 4 is performed as part of the processing performed in 210 in FIG. 2. In the example embodiment depicted in FIG. 1, the processing in FIG. 4 may be performed by analysis subsystem 110 of NAMS 100. The method presented in FIG. 4 and described below is intended to be illustrative and non-limiting. The particular series of processing steps depicted in FIG. 4 is not intended to be limiting. It is noted that even though FIG. 4 describes the operations in the flow chart as a sequential process, many of the operations can be performed in parallel or concurrently. In addition, the order of the operations may be rearranged. An operation may have additional steps not included in the figure. Some operations may be optional, and thus may be omitted in various embodiments. Some operations described in one block may be performed at another block. Furthermore, embodiments of the methods may be implemented by hardware, software (e.g., code, program, instructions executed by one or more processors), or combinations thereof.

At 410, network data 122, such as a set of network records, may be collected by or received by NAMS 100. For example, NAMS 100 may receive a set of network records for a particular network being managed or which is to be managed, such as for network 102 (or network 104). In some embodiments, the network records may be collected from or provided by one or more network controllers in the network. The network records may include multiple attributes, such as, for example, a type of application (e.g., audio or video stream), source and destination endpoints of the application (e.g., source or destination IP address), physical or logical ports used, transport layer protocols used (e.g., Transmission Control Protocol (TCP) and User Datagram Protocol (UDP)), flow characteristics (e.g., flow ID, time of delay, data volume, and duration), number of input packets, the number of output packets, the number of dropped packets, and the number of error packet, etc. for a network transaction, and the like. The network data may also include latency information related to the network. Various different protocols may be used to collect the network records such as OpenFlow or other protocols.

At 420, the set of network records received in 410 may optionally be pre-processed. Processing performed in 420 may include, for example, organizing the received network data into blocks of data for individual time periods. Processing performed in 420 may also include, for example, for each network record, subdividing a field or an attribute (e.g., an IP address) of the network record into sub-fields (e.g., 8-bit sub-fields). In some embodiments, data in a field or an attribute of the network records may be normalized such that the pre-processed data for the attribute is between 0 and 1. The data processing in 420 may be performed as soon as the network data collected at 410 becomes available or at some later time. In some embodiments, the pre-processed data may be output to a user via a user interface.

At 430 and 440, multiple analysis techniques are applied to the network data. For sake of simplicity, the processing depicted in FIG. 4 assumes that two analysis techniques are applied. This however is not intended to be limiting. In alternative embodiments, more than two analysis techniques may be applied.

At 430, a first analysis technique is applied to the set of network records to generate first analysis result(s). The first analysis technique may be, for example, a machine learning technique or other advanced technique for data analysis. The machine learning technique may be a supervised, unsupervised, or reinforcement learning technique. Examples of supervised learning techniques include K-nearest neighbor (KNN), Naïve Bayes, logistic regression, support vector machine (SVM), and others. Other supervised learning analysis techniques include linear or polynomial regression analysis, decision tress analysis, and random forests analysis. Examples of unsupervised learning analysis techniques include association analysis, clustering analysis, dimensionality reduction analysis, hidden Markov model analysis techniques, and others. Examples of clustering analysis techniques include K-means, principal component analysis (PCA), singular value decomposition (SVD), incremental clustering, and probability-based clustering techniques. The reinforcement learning technique may be, for example, a Q-learning analysis technique. The techniques described above are some examples of machine learning techniques that may be used in network analysis and management. These are not intended to be limiting.

The first analysis technique may be applied to a particular set of fields or attributes of the network records, where the particular set may be less than all the field or attributes of the network records. For example, the first analysis technique may be an FP technique, a latent Dirichlet allocation (LDA) analysis technique, an Apriori analysis technique, or an FP-growth analysis technique applied to those attributes storing categorical data (e.g., transport layer protocols and types of user application) in the network records.

At 440, a second analysis technique may be applied to the set of network records to generate second analysis result(s). The second analysis technique may be any one of the various analysis techniques discussed above in block 430. In certain embodiments, the second analysis technique may be different from the first analysis technique applied in 430. For example, if the first analysis technique is applied to those attributes storing categorical data in 430, a K-means, principal component analysis (PCA), singular value decomposition (SVD), incremental clustering, or probability-based clustering analysis technique may be applied to those attributes storing numerical data (e.g., numbers of packets, time delays, latencies) in the set of network records in 440.

In some embodiments, the first analysis technique in 430 and the second analysis technique in 440 may be applied to the same set of fields or attributes of the network records. In some other embodiments, the two analysis techniques may be applied to different sets of fields or attributes of the network records. For example, the first analysis technique may be applied in 430 to a first set of fields or attributes of the network records and the second analysis technique may be applied in 440 to a second set of fields or attributes where the second set of fields or attributes is different from the first set of fields or attributes. In certain embodiments, there may be no overlap between the fields or attributes that are used in 430 and the fields or attributes used for the processing in 440. If a third analysis technique is applied, it may be applied to a third set of fields or attributes of the network records that may be different from the first set or the second set of fields or attributes of the network records, and so on.

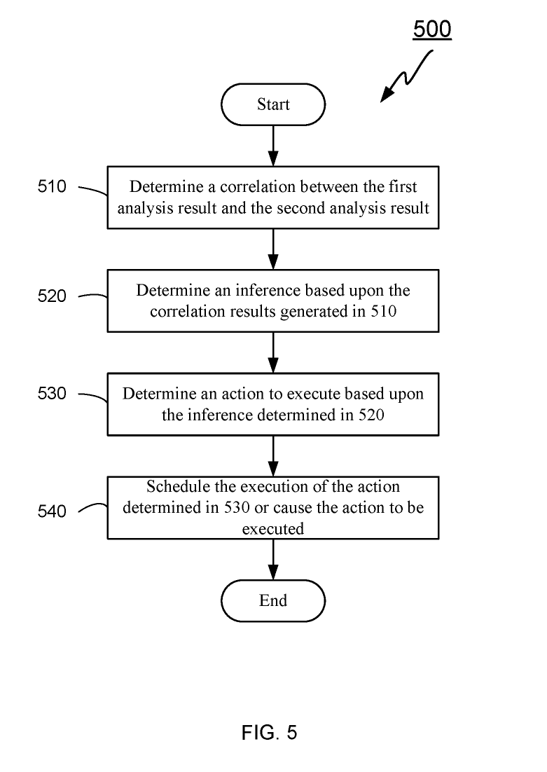

FIG. 5 is a high-level flow chart 500 illustrating processing performed for action recommendation according to certain embodiments. In certain embodiments, the processing depicted in FIG. 5 is performed as part of the processing performed in 220 in FIG. 2. In the example embodiment depicted in FIG. 1, the processing in FIG. 5 may be performed by analysis subsystem 110 and action recommendation subsystem 140 of NAMS 100. The method presented in FIG. 5 and described below is intended to be illustrative and non-limiting. The particular series of processing steps depicted in FIG. 5 is not intended to be limiting.

At 510, processing is performed to determine a correlation between the first analysis results generated in 430 in FIG. 4 and the second analysis results generated in 440 in FIG. 4.

At 520, an inference is determined based upon the correlation results generated in 510. In certain embodiments, a set of inference rules may be used to determine the inference in 520. The inference may identify one or more past, present, or future conditions or events associated with a network whose network data is being analyzed.

At 530, an action (or multiple actions) to be executed is determined based upon the inference determined in 520. In certain embodiments, an action table may be used to determine the action to be performed. In one embodiment, as part of the processing in 530, for a particular condition identified by the inference in 520, the action table is searched to find a matching condition. One or more actions corresponding to the matching condition in the action table are then identified as the actions to execute. For example, if the inference identifies a network device fault condition, the corresponding action may include changing the routing tables to bypass that network device. As another example, if the inference predicts a future network congestion condition, the action table may indicate that the corresponding action to be performed includes configuring network devices of the network to route data traffic differently just prior to and during the time when the network congestion is predicted to occur. In some embodiments, the action may include at least one of rerouting network traffic through a high-bandwidth path or rerouting network traffic through a low-latency path. In some instances, the action may include notifying a user of the condition, such as notifying a system administrator of the condition or event indicated by the inference.

At 540, the action determined in 540 may be executed or may be scheduled for execution. In some instances, the action may be scheduled to execute promptly if, for example, a network fault or a network anomaly is identified in the inference. In some instances, the action may be scheduled such that the action starts and finishes execution prior to the occurrence of the predicted future event identified in the inference. In this manner, the actions can be performed in anticipation of the predicted event identified in the inference.

It is noted that even though FIG. 5 describes the operations in the flow chart of FIG. 5 as a sequential process, many of the operations can be performed in parallel or concurrently. In addition, the order of the operations may be rearranged. An operation may have additional steps not included in the figure. Some operations may be optional, and thus may be omitted in various embodiments. Some operations described in one block may be performed at another block. Furthermore, embodiments of the methods may be implemented by hardware, software, firmware, middleware, microcode, hardware description languages, or any combination thereof.

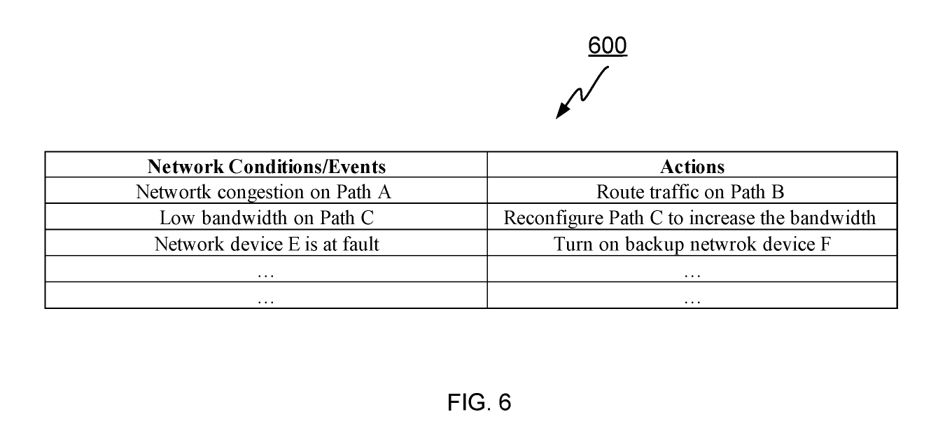

FIG. 6 illustrates an example action table 600 according to certain embodiments. Action table 600 stores a set of action rules, where an action rule identifies a condition or event and one or more actions to perform when the condition or event is indicated in an inference. In certain embodiments, the entries in action table 600 may be configured by a user of NAMS 100. For example, a user may manually set or alter the entries in action table 600 as desired. In certain other embodiments, the action table or certain entries within action table 600 may be automatically generated, such as by analysis engine 116 depicted in FIGS. 1 and 3.

In the example action table 600 depicted in FIG. 6, three conditions and corresponding actions are specified. If an inference identifies a “Network congestion on Path A” condition, then the corresponding action to execute is to “Route network traffic on Path B”, where Path B may be an alternate route to Path A but with less congestion. If an inference identifies a “Low bandwidth on Path C” condition, then the corresponding action to execute is to “Reconfigure Path C to increase the bandwidth”. If an inference indicates a “Network device E is at fault” condition then the corresponding action to execute is to “Turn on backup network device F”.

### Specific Use Case Examples

The following section provides specific use case examples. These examples are being provided for illustration purposes only, and are not intended to be limiting.

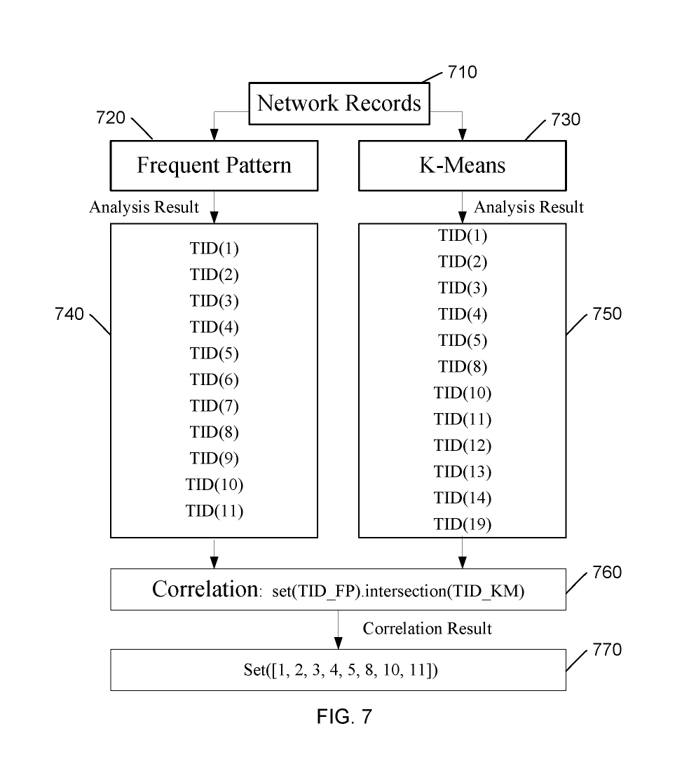

FIG. 7 illustrates a specific use case example that uses Frequent Pattern (FP) analysis and K-Mean analysis techniques. In the example shown in FIG. 7, two machine learning techniques are used. The first analysis technique that is used is FP analysis technique, which is a type of association analysis technique. The second analysis technique that is used is K-means analysis technique, which is a type of clustering analysis technique.

An association analysis technique such as the FP technique or latent Dirichlet allocation (LDA) technique may be used to find patterns in categorical datasets. The FP technique may be used to find relationships among the network records. Moreover, an FP technique may help in data indexing, classification, clustering, and other data mining tasks.

A clustering technique clusters data with similar properties (e.g., defined by a specific distance-measuring approach, such as Euclidean space) into clusters or groups. Several clustering techniques are known, such as K-means, principal component analysis (PCA), singular value decomposition (SVD), incremental clustering, and probability-based clustering method. The K-means technique can be used to form clusters in numeric domains and partition data into disjoint clusters with the nearest mean, where “K” represents the number of clusters.

As shown in FIG. 7, an FP technique 720 and a K-means technique 730 are applied to network records 710 representing the network data collected by NAMS 100 for a particular network being analyzed and managed. For example, in FIG. 1, network records 710 may be for network 102 representing network data collected for network 102 for a period of time. Network records 710 may include multiple records numbering a few hundreds, a few thousands, tens of thousands, or even more network records.

In the example in FIG. 7, each network record 710 has multiple attributes. For example, network records 710 may include the following network record:

TID(1)=[10.0.1.10, 10.0.1.111, 63918, 8100, 10, Appl-1, 11125, 108, 121, 0].

This network record has ten (10) comma-delimited fields or attributes. TID(1) represents the identification of the network record. The fields or attributes include:
Attribute #1: Source IP address (10.0.1.10 for the above record);
Attribute #2: Destination IP address (10.0.1.111 for the above record);
Attribute #3: Source port number (63918 for the above record);
Attribute #4: Destination port number (8100 for the above record);
Attribute #5: Output interface (10 for the above record);
Attribute #6: Application identifier identifying an application generating the network traffic (Appl-1 for the above record);
Attribute #7: Number of output packets (11125 for the above record);
Attribute #8: Number of input packets (108 for the above record);
Attribute #9: Number of dropped packets (121 for the above record); and
Attribute #10: Number of error packets (0 for the above record).

In certain embodiments, FP technique 720 may be applied to records 710 independent of K-means technique 730. Accordingly, processing for techniques 720 and 730 may be performed sequentially or in parallel.

In certain embodiments, FP technique 720 is applied to attributes of network records 710 that store categorical data. In the present example with network records having the ten attributes described above, attributes 1-6 represent attributes that store categorical values. Accordingly, only attributes 1-6 may be used for the FP technique analysis.

An analysis result is generated from applying FP technique 720. For this example, The analysis result generated from applying FP technique 720 includes the eleven records shown in Table 1.

TABLE 1
Analysis Result of Frequent Pattern Technique

| TID(1) = | [10.0.1.10, 10.0.1.111, 63918, 8000, 10, Appl-1, 11125, |
|---|---|
| | 108, 121, 0] |
| TID(2) = | [10.0.1.10, 10.0.1.121, 63212, 8000, 10, Appl-1, 3560, |
| | 189, 18, 2] |
| TID(3) = | [10.0.1.10, 10.0.1.131, 57221, 8000, 10, Appl-1, 88289, |
| | 15, 6, 0] |
| TID(4) = | [10.0.1.10, 10.0.1.141, 57125, 8000, 10, Appl-1, 2176, |
| | 282, 3, 9] |
| TID(5) = | [10.0.1.10, 10.0.1.161, 51025, 8000, 10, Appl-1, 1857, |
| | 2659, 12, 2] |
| TID(6) = | [10.0.1.10, 10.0.1.162, 62025, 8000, 10, Appl-1, 9928, |
| | 2218, 0, 0] |
| TID(7) = | [10.0.1.10, 10.0.1.101, 62126, 8000, 10, Appl-1, 8862, |
| | 2168, 0, 0] |
| TID(8) = | [10.0.1.10, 10.0.1.211, 39125, 8000, 10, Appl-1, 10928, |
| | 81, 10, 8] |
| TID(9) = | [10.0.1.10, 10.0.1.221, 67137, 8000, 10, Appl-1, 33571, |
| | 206, 0, 0] |
| TID(10) = | [10.0.1.10, 10.0.1.108, 61228, 8000, 10, Appl-1, 22831, |
| | 3112, 19, 6] |
| TID(11) = | [10.0.1.10, 10.0.1.119, 52228, 8000, 10, Appl-1, 261290, |
| | 8890, 12, 15] |

The analysis result shown in Table 1 can be represented by a result set 740 as: TID_FP=[1, 2, 3, 4, 5, 6, 7, 8, 9, 10, 11]. This result set identifies a pattern including a set of records related to Appl-1 application.

In certain embodiments, K-Means technique 730 is applied to attributes of network records 710 that store numerical values. In the present example with network records having the ten attributes described above, attributes 7-10 represent attributes that store numerical values. Accordingly, only attributes 7-10 may be used for the K-Means technique analysis.

An analysis result is generated from applying K-Means technique 730. For this example, the analysis result generated from applying K-Means technique 730 includes the twelve records shown in Table 2.

TABLE 2
Analysis Result of K-Means Analysis Technique

| TID(1) = | [10.0.1.10, 10.0.1.111, 63628, 8000, 10, Appl-1, 11125, |
|---|---|
| | 108, 121, 0] |
| TID(2) = | [10.0.1.10, 10.0.1.121, 63212, 8000, 10, Appl-1, 3560, |
| | 189, 18, 2] |
| TID(3) = | [10.0.1.10, 10.0.1.131, 57221, 8000, 10, Appl-1, 88289, |
| | 15, 6, 0] |
| TID(4) = | [10.0.1.10, 10.0.1.141, 57125, 8000, 10, Appl-1, 2176, |
| | 282, 3, 9] |
| TID(5) = | [10.0.1.10, 10.0.1.161, 51025, 8000, 10, Appl-1, 1857, |
| | 2659, 12, 2] |
| TID(8) = | [10.0.1.10, 10.0.1.211, 39125, 8000, 10, Appl-1, 10928, |
| | 81, 10, 8] |
| TID(10) = | [10.0.1.10, 10.0.1.108, 61228, 8000, 10, Appl-1, 22831, |
| | 3112, 19, 6] |
| TID(11) = | [10.0.1.10, 10.0.1.119, 52228, 8000, 10, Appl-1, 261290, |
| | 8890, 12, 15] |
| TID(12) = | [10.0.1.10, 10.0.1.21, 67337, 8000, 10, Appl-1, 55181, |
| | 206, 9, 0] |
| TID(13) = | [10.0.1.10, 10.0.1.101, 63337, 53, 10, Appl-2, 683195, |
| | 206, 2019, 0] |
| TID(14) = | [10.0.1.10, 10.0.1.201, 63337, 53, 10, Appl-2, 983195, |
| | 229, 2167, 10] |
| TID(19) = | [10.0.1.10, 10.0.1.223, 62297, 53, 10, Appl-2, 10573, |
| | 306, 29, 21] |

The analysis result shown in Table 2 can be represented by a result set 750 as: TID_KM=[1, 2, 3, 4, 5, 8, 10, 11, 12, 13, 14, 19]. This result set represents a cluster generated by the K-means analysis that represents a nascent congestion cluster.

At 760, a correlation is performed between the analysis result generated by applying FP technique 720 and the analysis result generated by applying K-means technique 730. In one embodiment, the correlation operation corresponds to finding the intersection between result set 740 and result set 750. The correlation thus finds an intersection between results sets TID_FP and TID_KM. For the above example, this correlation operation yields a correlation result 770 comprising a set of eight records, namely records with TIDs [1, 2, 3, 4, 5, 8, 10, 11].

An inference may then be determined based on correlation result 770. Since result set 740 identifies records related to application Appl-1, and result set 750 identifies a cluster found to create nascent congestion, the intersection of the two results identifies a condition where application Appl-1 may be causing network congestion. In the present example, the inference may thus indicate a past condition that Appl-1 caused network congestion at the time when network records 710 were captured.

One or more actions may then be determined by NAMS 100 in response to the inference. For example, the one or more actions may include an action to reduce congestion caused by application Appl-1, for example, the bandwidth available to the application may be increased.

The example shown in FIG. 7 and described above is being provided for illustration purposes only, and is not intended to be limiting. In some other use case examples, a first analysis technique, such as a latent Dirichlet allocation (LDA) analysis technique, an Apriori analysis technique, or an FP-growth analysis technique, may be applied to those attributes storing categorical data (e.g., transport layer protocols, types of user application, IP addresses, types of network interfaces etc.) in the set of network records. In some other use case examples, a second analysis technique, such as a principal component analysis (PCA) technique, a singular value decomposition (SVD) technique, an incremental clustering technique, or a probability-based clustering technique, may be applied to those attributes storing numerical data (e.g., numbers of packets, time delays, latencies) in the set of network records. A correlation between the results from any of the first analysis technique described above and any of the second analysis technique described above, such as an intersection of the result from the first analysis technique and the result from the second analysis technique, may be performed to determine an inference related to the network from which the set of network records is obtained. An action may then be determined for the network based on the inference.

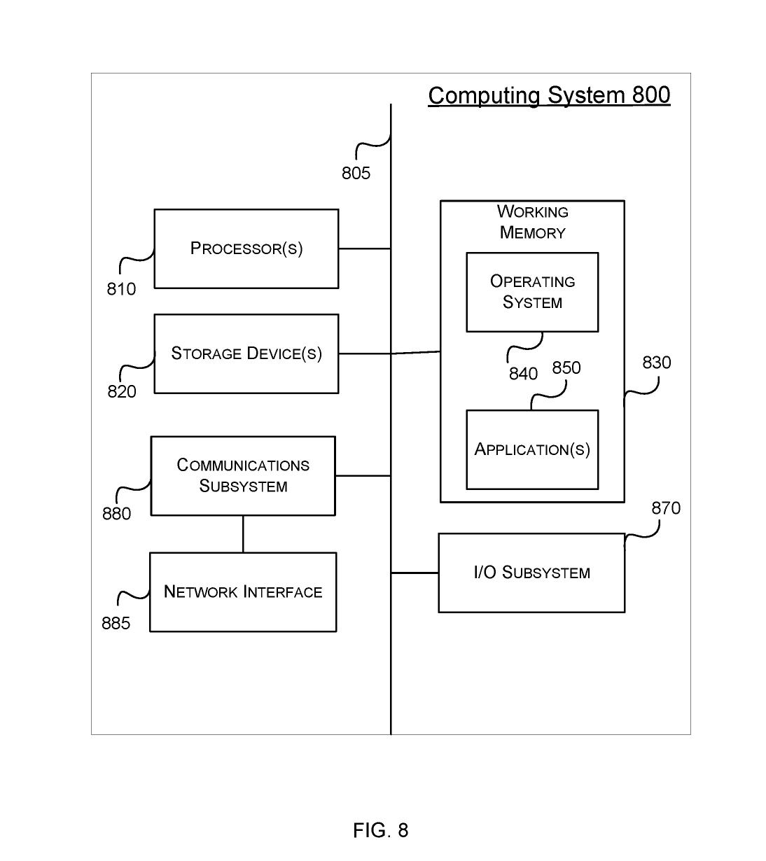

FIG. 8 depicts a simplified block diagram of a computing system or device 800 that may be used to implement a network analysis and management system and that can perform the various methods and functions described above according to certain embodiments. In certain embodiments, computing system 800 may be used to implement NAMS 100 depicted in FIG. 1. FIG. 8 is meant only to provide a generalized illustration of various components, any and/or all of which may be utilized as appropriate. In certain embodiments, the components of computing system 800 may be included in a network device (e.g., a router or a switch) that is configured to perform the functions performed by a network analysis and management system described above, such as NAMS 100.

As shown in FIG. 8, computing system 800 includes various hardware elements that can be electrically coupled via a bus 805 (or may otherwise be in communication, as appropriate). Bus 805 may include a physical interface for connecting to a cable, socket, port, or other connection to the external communication medium. Bus 805 may further include hardware and/or software to manage incoming and outgoing transactions. Bus 805 may implement a local bus protocol, such as NVMe, AHCI, SCSI, SAS, SATA, PATA, PCI/PCIe, and the like.

The various hardware elements may include one or more processors 810 configured to perform a subset or all of the functions described above, including without limitation one or more general-purpose processors and/or one or more special-purpose processors (such as digital signal processing chips, graphics acceleration processors, and/or the like). Examples of processors 810 include processors developed by ARM, MIPS, AMD, Intel, Qualcomm, and the like. Processors 810 may also be implemented in an application-specific integrated circuit (ASIC) or a field-programmable gate array (FPGA). The hardware elements of computing system 800 may also include an I/O subsystem 870, which can include without limitation input devices such as a mouse, a keyboard, and the like, and output devices such as a display unit, a printer, a video player, an audio player, and/or the like.

Computing system 800 may further include (and/or be in communication with) one or more non-transitory storage devices 820, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like. In some cases, some or all of the storage devices 820 may be internal to computing system 800, while in other cases some or all of storage devices 820 may be external to computing system 800.

Computing system 800 might also include a communications subsystem 880, which can include without limitation a modem, a network card (wireless or wired), an infrared communication device, a wireless communication device and/or chipset (such as a Bluetooth® device, an 802.11 device, a Wi-Fi device, a WiMAX device, cellular communication facilities, etc.), and/or the like. The communications subsystem 880 may permit data to be exchanged between computing system 800 and a network (via a network interface 885), other computing systems, and/or any other devices, such as network controllers described herein.

In many embodiments, computing system 800 may further comprise a non-transitory working memory 830, which can include a random access memory (RAM) or read-only memory (ROM) device, as described above. The computing system 800 also can comprise software elements, shown as being currently located within working memory 830, including an operating system 840, device drivers, executable libraries, and/or other code, such as one or more application programs 850, which may comprise computer programs provided by various embodiments, and/or may be designed to implement methods, and/or configure systems, provided by other embodiments, as described herein. Merely by way of example, one or more procedures described with respect to the method(s) discussed above, for example as described with respect to FIGS. 4 and 7, might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 820 described above. In some cases, the storage medium might be incorporated within a computing system, such as computing system 800. In other embodiments, the storage medium might be separate from a computing system (e.g., a removable medium, such as a compact disc), and/or provided in an installation package, such that the storage medium can be used to program, configure and/or adapt a general purpose computer with the instructions/code stored thereon. These instructions might take the form of executable code or instructions executable by the computing system 800 and/or might take the form of source and/or installable code, which, upon compilation and/or installation on the computing system 800 (e.g., using any of a variety of generally available compilers, installation programs, compression/decompression utilities, etc.) then takes the form of executable code.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Features described with respect to certain embodiments may be combined in various other embodiments. Different aspects and elements of the embodiments may be combined in a similar manner. Technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to be limiting. Rather, the preceding description of the embodiments will provide those skilled in the art with an enabling description for implementing certain embodiments. Various changes may be made in the function and arrangement of elements. Where components or modules or systems are described as being configured to perform certain operations, such configuration can be accomplished, e.g., by designing electronic circuits to perform the operation, by programming programmable electronic circuits (such as microprocessors) to perform the operation such as by executing computer instructions or code, or any combination thereof.

Also, some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

Having described several embodiments, various modifications, alternative constructions, and equivalents may be used without departing from the spirit of the disclosure. For example, the above elements may merely be a component of a larger system. A number of steps may be undertaken before, during, or after the above elements are considered. Accordingly, the above description does not limit the scope of the disclosure.

Other modifications, variations and alternatives are also possible. The specifications and drawings are, accordingly, to be regarded in an illustrative rather than in a restrictive sense.

Some embodiments may include a variety of storage media and computer readable media for storing data and instructions for performing the disclosed methods. Storage media and computer readable media for containing code, or portions of code, can include any appropriate media known or used in the art, including storage media and communication media, such as but not limited to volatile and non-volatile, removable and non-removable media including RAM, ROM, Electrically Erasable Programmable Read-Only Memory (“EEPROM”), flash memory or other memory technology, Compact Disc Read-Only Memory (“CD-ROM”), digital versatile disk (DVD) or other optical storage, magnetic cassettes, magnetic tape, magnetic disk storage or other magnetic storage devices or any other medium which can be used to store the desired information and which can be accessed by a system device. Based on the disclosure and teachings provided herein, a person of ordinary skill in the art will appreciate other ways and/or methods to implement the various embodiments.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Various embodiments of this disclosure are described herein, including the best mode known to the inventors for carrying out the disclosure. Variations of those embodiments may become apparent to those of ordinary skill in the art upon reading the foregoing description. The inventors expect skilled artisans to employ such variations as appropriate and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A method comprising:
applying, by a computing system, a first analysis technique to a set of network records to generate a first analysis result, the set of network records comprising network data collected for a network comprising a plurality of network devices, wherein each network record of the set of network records comprises a plurality of attributes;
applying, by the computing system, a second analysis technique to the set of network records to generate a second analysis result;
determining, by the computing system, a correlation between the first analysis result and the second analysis result;
determining, by the computing system and based upon the correlation, an inference related to the network; and
determining, by the computing system and based upon the inference, an action to take for the network.

2. The method of claim 1, wherein:
applying the first analysis technique comprises applying the first analysis technique to a first set of attributes from the plurality of attributes of the set of network records; and
applying the second analysis technique comprises applying the second analysis technique to a second set of attributes from the plurality of attributes of the set of network records, wherein the second set of attributes is different from the first set of attributes.

3. The method of claim 2, wherein:
the first set of attributes comprises a categorical attribute; and
the second set of attributes comprises a numerical attribute.

4. The method of claim 3, wherein:
the first analysis technique comprises at least one of a frequent pattern (FP) analysis technique, a latent Dirichlet allocation (LDA) analysis technique, an Apriori analysis technique, or an FP-growth analysis technique; and
the second analysis technique comprises at least one of a K-means analysis technique, a principal component analysis (PCA) technique, a singular value decomposition (SVD) technique, an incremental clustering technique, or a probability-based clustering technique.

5. The method of claim 1, wherein:
the first analysis technique is different from the second analysis technique; and
the first analysis technique and the second analysis technique are applied to a same set of attributes of the plurality of attributes.

6. The method of claim 1, further comprising selecting, by the computing system, the first analysis technique and the second analysis technique based at least partially on the set of network records.

7. The method of claim 1, wherein determining the correlation between the first analysis result and the second analysis result comprises selecting a correlation rule for the correlation from a set of correlation rules.

8. The method of claim 1, wherein the correlation comprises an intersection of the first analysis result and the second analysis result.

9. The method of claim 1, wherein the inference identifies a network condition or event.

10. The method of claim 9, wherein the network condition or event comprises a predicted future network condition or event.

11. The method of claim 1, wherein determining the action to take comprises:
storing, in an action table, a plurality of network conditions or events and actions corresponding to the plurality of network conditions or events;
identifying a network condition or event based upon the inference;
searching the action table to identify a matching network condition or event in the action table using the network condition or event identified based upon the inference; and
identifying an action corresponding to the matching network condition or event in the action table as the action to take.

12. The method of claim 1, wherein the action affects at least one network device from the plurality of network devices.

13. The method of claim 1, wherein the action comprises rerouting network traffic through a high-bandwidth path or rerouting network traffic through a low-latency path.

14. The method of claim 1, further comprising scheduling the determined action for execution.

15. A system comprising:
a memory configured to store a set of network records, the set of network records comprising network data collected for a network comprising a plurality of network devices, wherein each network record of the set of network records comprises a plurality of attributes; and
one or more processing entities coupled to the memory,
wherein the one or more processing entities are configured to:
apply a first analysis technique to the set of network records to generate a first analysis result;
apply a second analysis technique to the set of network records to generate a second analysis result;
determine a correlation between the first analysis result and the second analysis result;
determine, based upon the correlation, an inference related to the network; and
determine, based upon the inference, an action to take for the network.

16. The system of claim 15, wherein the one or more processing entities are configured to:
apply the first analysis technique to a first set of attributes from the plurality of attributes of the set of network records; and
apply the second analysis technique to a second set of attributes from the plurality of attributes of the set of network records, wherein the second set of attributes is different from the first set of attributes.

17. The system of claim 16, wherein:
the first set of attributes comprises a categorical attribute; and
the second set of attributes comprises a numerical attribute.

18. A non-transitory computer-readable storage medium including machine-readable instructions stored thereon, the instructions, when executed by one or more processing entities, causing the one or more processing entities to:
apply a first analysis technique to a set of network records to generate a first analysis result, the set of network records comprising network data collected for a network comprising a plurality of network devices, wherein each network record of the set of network records comprises a plurality of attributes;
apply a second analysis technique to the set of network records to generate a second analysis result;
determine a correlation between the first analysis result and the second analysis result;
determine, based upon the correlation, an inference related to the network; and
determine, based upon the inference, an action to take for the network.

19. The non-transitory computer-readable storage medium of claim 18, wherein the instructions, when executed by the one or more processing entities, cause the one or more processing entities to:
apply the first analysis technique to a first set of attributes from the plurality of attributes of the set of network records; and
apply the second analysis technique to a second set of attributes from the plurality of attributes of the set of network records, wherein the second set of attributes is different from the first set of attributes.

20. The non-transitory computer-readable storage medium of claim 19, wherein:
the first set of attributes comprises a categorical attribute; and
the second set of attributes comprises a numerical attribute.
